(19) United States
(12) Patent Application Publication
(10) Pub. No.: US 2018/0053229 A1
(43) Pub. Date: Feb. 22, 2018

(54) Community-Based Transportation Management System

(71) Applicant: HBSS Connect Corp., Lowell, MA (US)

(72) Inventors: Himanshu Bhatnagar, North Andover, MA (US); Shalabh Bhatnagar, Nashua, NH (US); Mital Parikh, Andover, MA (US); Edward Amazeen, Bedford, MA (US); David Romanoff, Worcester, MA (US); Vikash Kumar, Lowell, MA (US); Arjun Bhatnagar, North Andover, MA (US); Hui Li, Lowell, MA (US)

(73) Assignee: HBSS Connect Corp., Lowell, MA (US)

(21) Appl. No.: 15/680,173

(22) Filed: Aug. 17, 2017

Related U.S. Application Data
(60) Provisional application No. 62/376,360, filed on Aug. 17, 2016.

(51) Int. Cl. G06Q 30/06; G06Q 30/08; G06Q 50/30; G06Q 20/10; G06Q 20/32

(52) U.S. Cl. CPC G06Q 30/0605; G06Q 30/08; G06Q 20/3274; G06Q 50/30; G06Q 20/10; G06Q 30/0613

(57) ABSTRACT

Systems and methods for community-based transportation management, transportation funding and payment, transportation routing and scheduling, and transportation forecasting and marketplace trading are provided. The system may comprise a transportation planner module, a payment module, a scheduling and routing module, a forecasting module, and/or a marketplace module, each individually or in combination comprising one or more servers, databases, and instructions, in communication with a plurality of external user devices and one or more third-party transportation systems or vendors, for the purposes of transportation management, planning, routing, scheduling, and payment. The system can allow consumers and communities to plan and request trips and provide subsidies; invite contacts; allow vendors to forecast and bid on trips; communicate routing and schedule information; and provide payments. The present invention solves problems with the currently available transportation planning systems, including capacity problems, by providing systems and methods for improved planning, ordering, scheduling, bidding, pricing, and payment.

### FIELD OF THE INVENTION

The presently disclosed subject matter relates to transportation management, and more specifically, to systems and methods for community-based transportation management to optimize how users, individually and/or as a community, can request and plan one or more trips; and to optimize how transportation service vendors can provide and plan routes, obtain forecasting of transportation demand, bid on transit trips; and to optimize payments and subsidies and communication of routing and scheduling between users, communities, funding sources, and vendors.

### BACKGROUND OF THE INVENTION

Transportation is a basic human need, and as societies become more complicated, transportation infrastructure and transportation management have become more complex. At present, most transportation management is provided by government agencies, in the form of public transit systems, regulating air travel and marine travel and livery services (such as licensed taxi cabs), and building and maintaining road networks. There are also private transportation companies that supply supplements to public transit systems, and intra-state and inter-state travel, such as bus services and vanpools—operating as and sometimes referred to as third-party suppliers, or third-party transportation suppliers. More recently, the rise of ride-sharing services to orchestrate private vehicle-owners offering rides to consumers of transit (that is, any person who wants or needs a ride) has created a new market niche for easy on-demand access to customized transit, but has done nothing to resolve many of the existing problems with currently available transportation management systems and services.

Current transportation management infrastructure and systems do not allow for creation and definition of communities of consumers. If communities of consumers existed, each community might be able to find and book rides for members in advance. Communities might also be able to negotiate with government agencies, third-party suppliers of transportation including but not limited to providers of Medicaid transportation, and other transit vendors and middlemen to find better prices for consumers, and might be able to help manage payments and subsidies for consumers. At present, there is no system in place that allows a community to form, and then to build a community-based transportation management system utilizing a plurality of transportation providers. Additionally, there is no contacts-based transportation management, in which a user can access the user's known contact (in address information or on social media networks or other contacts), and use that contact information to set a trip and invite the user's contacts. Current ride-sharing services and marketplaces fail to provide an adequate function to meet this consumer need, because the current art puts users in cars with unknown transportation providers, and cannot allow conveniently grouped pickups and drop-offs.

Third-party suppliers are currently limited by the systems available, from communicating their routing and scheduling information to consumers directly, rather than to transportation management systems. For instance, when a consumer searches using any common mapping or public transit service, those services are only able to suggest public transit routes and schedules, and possibly real-time location information, supplied by public transit agencies. Private transit, such as third-party suppliers, is not included, and so consumers do not have simple and effective access to those transportation options separately or in combination with public transportation services.

While many marketplaces are implemented online—such as search engines including Google and Yahoo for finding general information or mapping; sales marketplaces such as eBay for individuals to sell and buy goods; advertising and listing marketplaces without sales functions, such as Craigslist; ride-hailing and ride-sharing services such as Lyft or Uber seeking to replace or supplement taxi services; and crowdfunding marketplaces such as GoFundMe at which individuals can solicit and receive donations from others—there is presently no online transportation marketplace, in which a plurality of consumers, or a plurality of communities, can share information about rides, routes, and schedules they want, individually and/or as a group, not just for the immediate future but for longer-term scheduling. As a corollary, there is not at present any system for transportation suppliers to bid on desired rides. This lack of information about demand for future rides, and lack of a marketplace for future rides, and lack of mapping information about consumers' desired pick-up locations, drop-off locations, and route data from transportation providers, leads to inefficiencies in transportation management and planning. The lack of any futures market for transit trips desired by consumers and/or communities also creates problems with pricing and leads to excess costs in time and money for consumers and communities. There is also no marketplace or transportation management system that allows for booking of multiple components of a transit-based trip from a centralized system, or for payment for such multiple components or for application of subsidies from multiple funding sources.

### SUMMARY OF THE INVENTION

The present invention meets all these needs, by disclosing systems, and methods, and instructions stored in non-transitory computer-readable media, for community-based transportation management, for transportation funding, for sharing of desired transit rides, for sharing and forecasting of routes and schedules and for planning routes and schedules, and a marketplace for posting desired future transit and bidding for future transit supply. As used in this disclosure of the present invention, the term “community” can mean any grouping of users: for instance, a community may be a neighborhood, a town, an apartment building, a company, a religious organization, a club, an organization that makes and/or distributes meals to individuals or other entities, or any other grouping of people for whom shared transportation options can increase efficiency or in some way benefit that community.

The goal of the present invention is to provide a solution for the shortcomings in the present art of transportation management, carried out on a variety of platforms including but not limited to computer-implemented marketplaces and platforms connecting consumers, communities, government transit agencies, private transit companies, and/or private individuals, including both paid and volunteer-provided transportation services. A further goal of the present invention is to assist communities in solving the real-world problems of insufficient transportation services—insufficient for the needs of that community. Together, the present invention provides transportation as a service (TAAS).

In the present invention, a user can define one or more communities, and a user can join one or more communities. Users can, individually or as members of a community, find rides for themselves or rides desired by a plurality of the members of a community (or more than one community). Furthermore, users can access and invite their contacts—including but not limited to community members, friends whose contact info (email, phone, or other unique contact information) the user has, connections on social media or chat platforms, in any combination—to a trip. This will lead to a better service for users than current ride-sharing or ride-pooling services, with the option for users to set more convenient pickups and drop-offs, and to prevent a user from being in a car with an unknown transportation provider, which users often find uncomfortable and is potentially unsafe.

The presently disclosed inventions allow a user to request and plan one or more trips on existing routes or infrastructure, which may be existing commercial for-profit or government-funded transportation services (or a blend of those).

The inventive systems and methods also create an online marketplace for transportation, which marketplace incorporates at least one search function for users to search for rides and/or for the system to search for rides that match the user's desired rides criteria, as discussed below in greater detail. In contrast to the prior art of transportation search tools, which are local or specific to a particular provider, the inventive system can search over a plurality of types of transportation: public, private, ride-sharing, and dynamic transportation systems. For users and communities, this allows posting of the rides that users will want, including locations where stops are or will be desired, and timing of stops, frequency of service, and expected or approximate volume of rides desired. Suppliers of transportation services can bid to meet the demand for transportation: the posted rides desired. Users and suppliers of transportation services can utilize advance and subscription booking of future transportation rides, on customizable schedules, benefiting both consumers seeking transportation, and companies or agencies seeking to provide transportation. In contrast to the present state of marketplaces for mapping, ride-sharing or ride-hailing, sales or listings, and collection of money or donations, the present invention presents systems and methods for integrating desired rides, mapping and routing, route and ride offerings, collection and payment of funds, and bidding for rides.

The present invention enables routing and scheduling of third-party transportation services, by allowing agencies and third-party suppliers of transportation to send or share digital information about schedules and route maps to the inventive system. This makes all routes and schedules searchable by consumers and communities. Agencies and third-party suppliers of transportation can also share real-time GPS data with the inventive system, to enable real-time mapping and schedule-planning by consumers and communities.

By integrating and communicating with the scheduling systems of a plurality of transportation providers, and by allowing third-party transportation suppliers to send or share their routing and schedule information, the present invention enables users (both individual consumers and communities) to book rides comprising a plurality of legs on a plurality of suppliers. The present invention includes payment methods and means, and when a user books a ride, the ride can be pre-paid with payment delivered by the inventive system to the appropriate suppliers, or to a subset of the plurality of the appropriate suppliers, even when a plurality of suppliers are providing different legs of the ride. The booking and payment functions can be utilized by a user booking a ride on behalf of herself or himself, and/or by a user or group of users on behalf of a community or subset of a community. The payment methods disclosed in the present disclosure include, but are not limited to, use of credit or debit cards; community-funded travel for individuals whether or not they are members of the community; individual accounts for users which may be funded by the user individually, by friends, by government funding or subsidies, by paycheck withholding, or by crowdfunding; and generating scannable codes to avoid the use of cash or credit or debit cards while boarding or on board a vehicle for one or any legs of the ride. By combining these approaches in a seamless community-based transportation management system, the present invention provides a comprehensive funding plan for users. The community-based transportation management system disclosed herein can be used by a community to create a captive transportation system that efficiently serves the needs of that community, drawing on existing government transportation services, and adding the community's own transportation resources and third-party transportation suppliers' resources. This inventive transportation funding is distinct from other types of crowdfunding. In crowdfunding in the prior art, the funds are raised and are given to a user, at which point they can be used by the user for anything. In the present invention, the inventive system holds the raised funds, and parcels the funds out to users using user devices for use only on approved transportation services. The funds are held for transport only, and the system identifies usage of funds on a per trip basis, and the use of funds can be audited.

By providing an online marketplace for transportation services, the present invention allows users to input their anticipated and intended rides—creating previously unavailable clarity and forecasting of future transportation demand. The online marketplace for transportation services allows government and third-party transportation suppliers to build supply to meet the anticipated demand, and allows bidding and planning for routes. In effect, this will change transportation and the sale and purchase of transportation and rides from a supplier's market to a buyer's market, leading to increased price efficiency and improved service, all of which will benefit users of any transportation service. By providing this online marketplace for public community transportation services management, the present invention creates a “futures market” for future demands for transportation services. This allows suppliers to bid to provide future transportation services, creating a sales pipeline for third-party transportation suppliers, making participation in the marketplace established by the present invention attractive to those third-party transportation suppliers. The suppliers can bid only after they have a ride that they can provide that matches the desired criteria of the user or community requesting the transportation services.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows a schematic depiction of an exemplary method of community-based transportation management, from the perspective of the inventive system.

FIG. 2 shows a schematic depiction of an exemplary method of community-based transportation management, from the perspective of a user device.

FIG. 3 shows a schematic depiction of an exemplary method of community-based transportation management, from the perspective of a third party.

FIG. 4 shows a schematic depiction of an exemplary method of providing a transportation marketplace, from the perspective of the inventive system.

FIG. 5 shows a schematic depiction of an exemplary method of providing a transportation marketplace, from the perspective of a user device.

FIG. 6 shows a schematic depiction of an exemplary method of providing a transportation marketplace, from the perspective of a third party.

FIG. 7 shows a schematic depiction of an exemplary method of user-based and community-based transportation funding and payment, from the perspective of the inventive system.

FIG. 8 shows a schematic depiction of an exemplary method of user-based and community-based transportation funding and payment, from the perspective of a user device.

FIG. 9 shows a schematic depiction of an exemplary method of user-based and community-based transportation funding and payment, from the perspective of a third party.

FIG. 10 illustrates the inventive system and the environment in which it operates, including multiple parties external to the system.

FIG. 11 shows an exemplary system configured to carry out the present invention, comprising a plurality of processors, a plurality of memories, a plurality of databases for storage of information related to transportation management, a plurality of computer-readable media for storing computer-readable instructions, and a plurality of input/out modules for communication with third-party transportation providers and/or with user devices, any of which may be assembled or built as any of several purpose-built modules.

FIG. 12 depicts a view of the inventive system, comprising a plurality of modules related to carrying out one or more functions of the present invention.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the methods and systems of the present invention.

The present subject matter discloses systems and methods for transportation management.

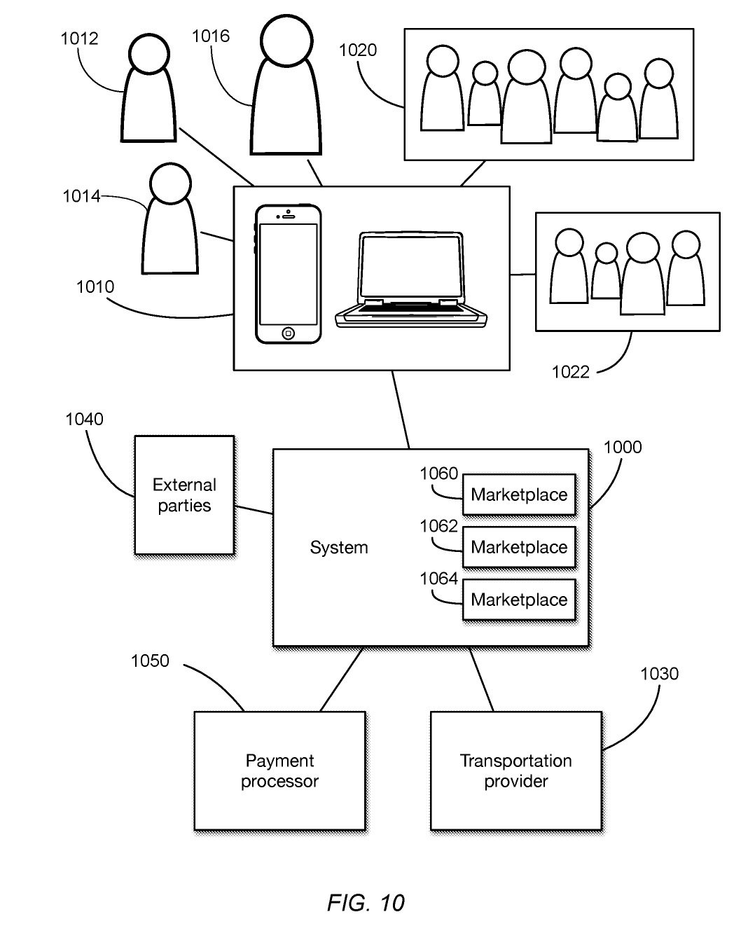

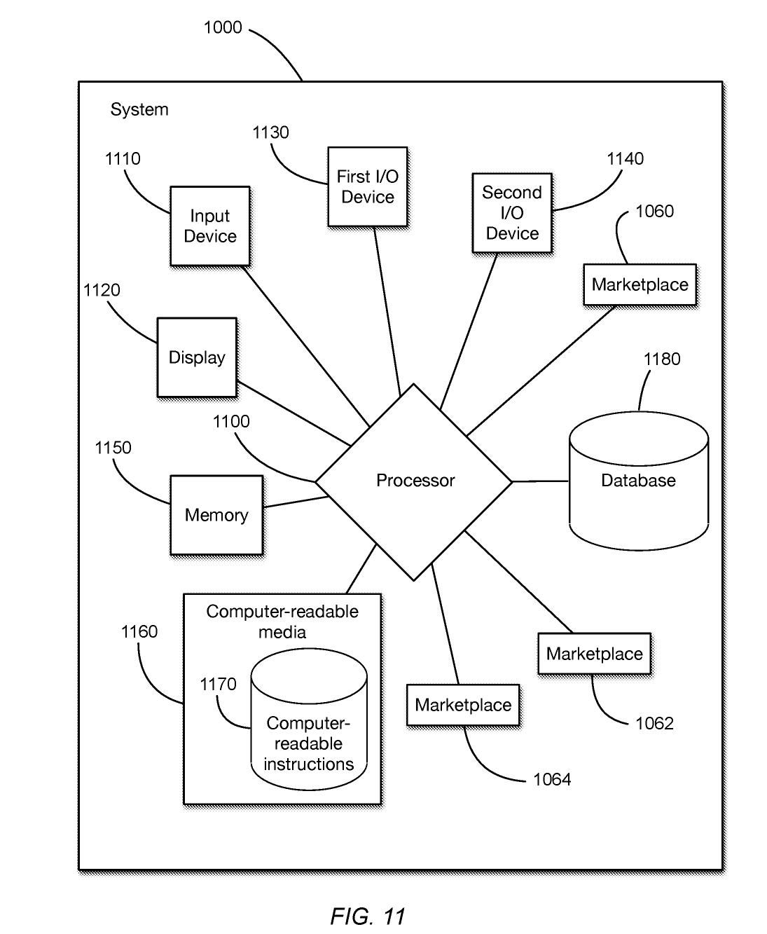

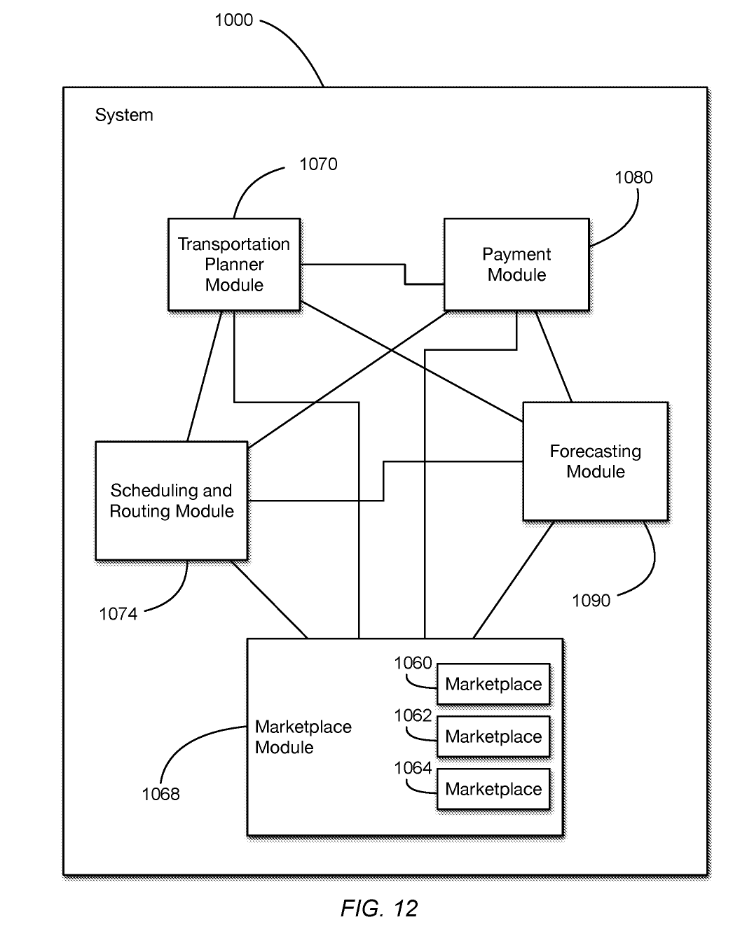

In the following descriptions of the inventive methods of the present disclosure, reference is made to structures and components of the system 1000; for further description of such structures and components, refer to the discussion of FIG. 11 and FIG. 12, below. Likewise, for further description of the terms used in the present disclosure, and of the parties external to the system 1000, refer to the discussion of FIG. 10, below.

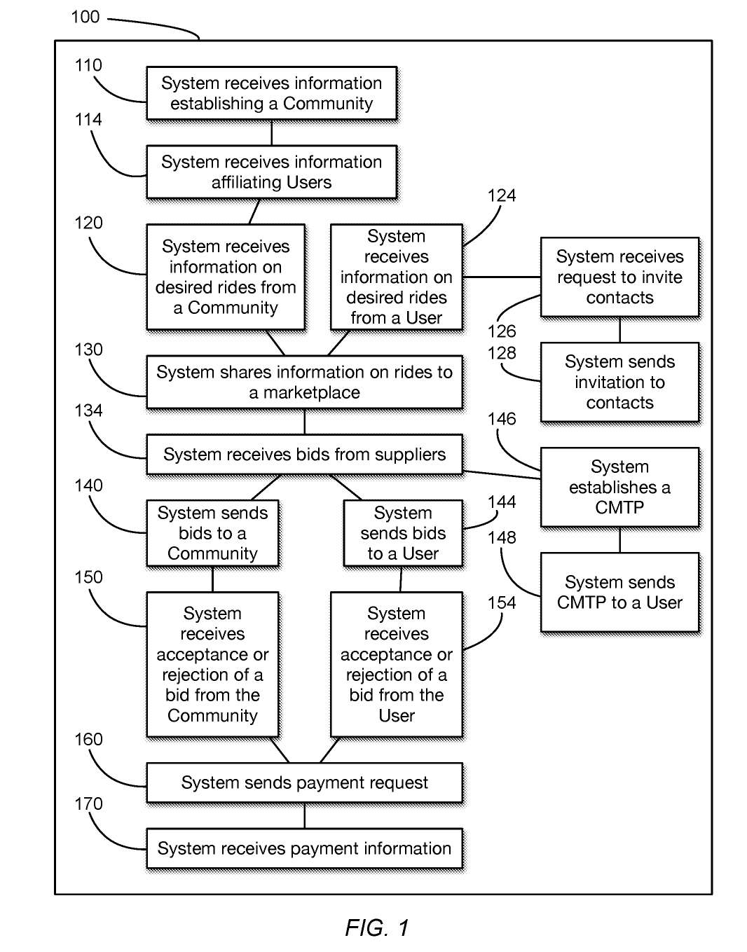

With reference to FIG. 1, a method 100 is presented, from the perspective of the system 1000, of the inventive system 1000 providing a method of community-based transportation management. In this inventive method 100, the system 1000 receives 110 information establishing a Community 1020. Thereafter, the system 1000 receives 114 information affiliating a plurality of Users 1012 with a Community 1020. A User 1012 may be affiliated with a plurality of Communities 1020, and it will be obvious to one of skill in the art that there may be a Community 1020, a different Community 1022, and a plurality of Communities. The system 1000 then communicates with the Community 1020. The system receives 120 information on desired rides from a Community 1020. The system receives 124 information on desired rides from a User 1012. In some embodiments of the present invention, the system 1000 may receive information from a plurality of individual Users 1012, and/or from a plurality of Communities 1020. The information received 124 by the system 1000 may comprise information about the ride itself, including but not limited to pick-up location and/or time, drop-off location and/or time, type or types of acceptable transportation, and other relevant data about the desired ride. The information received 124 by the system 1000 may also include information about the contacts of a particular User 1012. Such information can comprise individually-identifying contact information (for instance, an email address, phone number, or handle on a social media or other platform) for one or more contacts of the User 1012. The User 1012 may include information about the contacts of the User 1012 so that the User 1012 can invite contacts, including but not limited to friends, family members, and Community 1020 members, to participate in a particular ride or rides. All such information received 124 is also referred to individually and collectively as the ride criteria. The information received 124 by the system 1000 may include or be followed by the system 1000 receiving 126 a request to invite contacts of the User 1012 to the desired ride; after which the system 1000 may send 128 invitations to one or more of the specified contacts of the User 1012; such invitations comprise a request for the contact of the User 1012 to join the ride, and may comprise further items or requests.

Thereafter, the system shares 130 information on desired rides to a marketplace 1060. A desired ride is any transportation desired by a User 1012 or a Community 1020, whether the transportation comprises or requires one or more modes of transportation (e.g., car, bus, van, boat, bicycle, airplane, animal-powered transportation, or other), that involves travel from one place to another, whether or not the travel is intended as a round-trip, one-way, open-jaw, or other type of trip or booking, and whether or not the travel is for a single occurrence, or will recur. Once a User 1012 is in a Community 1020, the User 1012 can book Transportation Provider 1030 that provides rides to members of that Community 1020 (or with other Transportation Providers 1030), or an administrative User 1012 in a Community 1020 can book rides for any User 1012 who is a member of that Community.

The system 1000 receives 134 bids from Transportation Providers 1030, related to the Transportation Provider 1030 seeking to provide service for the desired rides as shared in the marketplace 1060. Thereafter, the system sends 140 bids to a Community 1020 and/or the system sends 144 bids to a User 1012. Later, the system receives 150 acceptance or rejection of a bid from a Community 1020 and/or the system receives 154 acceptance or rejection of a bid from a User 1012. After processing the acceptance or rejection of a bid, the system may send 160 a payment request to a Community 1020 or a User 1012. Thereafter, the system receives 170 payment information. In some embodiments of the present invention, the system 1000 may establish 146 a Community-Managed Transport Pass (“CMTP”). An administrative User 1012 in a Community 1020 can initiate or instruct the system 1000 to establish 146 one or more CMTPs to be given or sold to members of the Community 1020, so that the CMTPs function as discounted-ride passes for Community 1020 members. A CMTP may have limits placed on it by the administrative User 1012, including but not limited to limits with regard to the amount of money on it, the number of rides that may be discounted, how many rides or discounts may be used in a particular time period, and expiration; or the CMTP may not be limited. A CMTP may, it has been found advantageous, be generated as a virtual card, bar code, QR code, or similar item for display on the screen of a user device 1010 by a user 1014, or a CMTP may be generated to be printed or other made into a physical card for use at a point of transportation where a fare or cost is required. A CMTP could be used on multiple forms of transportation. A CMTP could be expanded, under the present invention, to encompass goods and services of interest and benefit to Community 1020 members, including but not limited to meals, school supplies such as books, shoes, and uniforms for school-age children, and other goods and services. After the system 1000 establishes 146 a CMTP, the system 1000 sends 148 the CMTP to a user 1012, a user 1014, a user 1016, or another user.

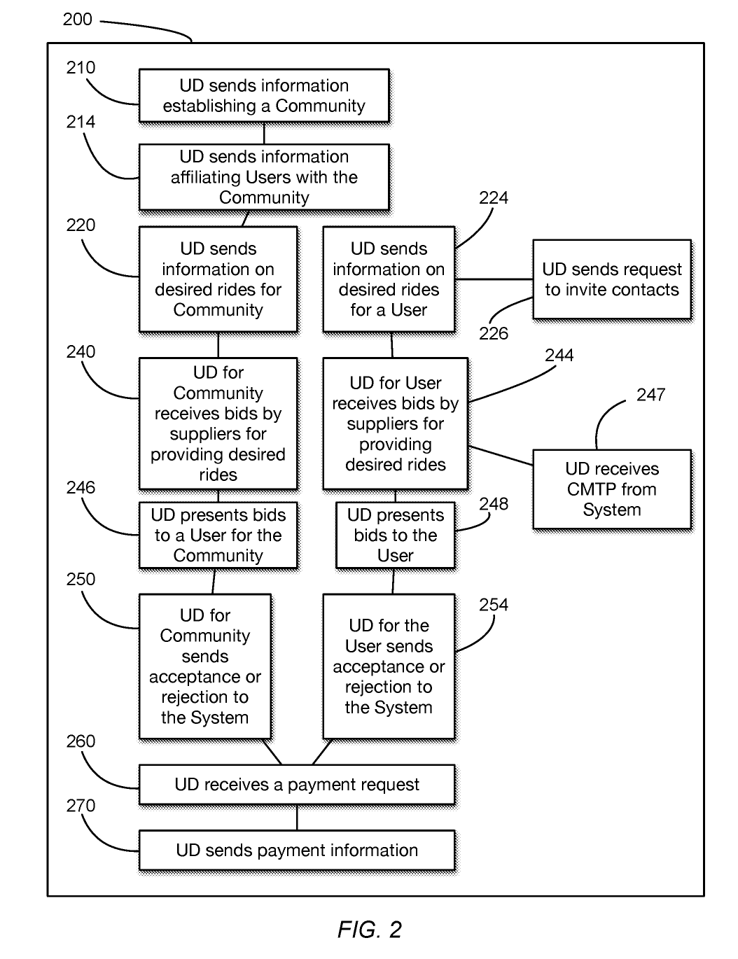

With reference to FIG. 2, a method 200 is presented, from the perspective of a user device 1010 (UD 1010), of the inventive system 1000 providing a method of community-based transportation management. In this inventive method 200, a UD 1010 sends 210 information establishing a Community 1020 to the inventive system 1000. The UD 1010 thereafter sends 214 information affiliating a plurality of Users 1012 with a Community 1020. Later, the UD 1010 sends 220 information (comprising some ride criteria) on desired rides for a Community 1020, and/or the same or a different UD 1010 sends 224 information on desired rides for a User 1012. It will be obvious to one of skill in the art that there may be a plurality of UD 1010 in operative communication with the inventive system 1000. The information the UD 1010 sends 224 may include or be followed by the UD 1010 sending 226 a request to invite contacts of the User 1012 to the desired ride; such invitations comprise a request for the contact of the User 1012 to join the ride, and may comprise further items or requests.

At a later time, a UD 1010 for a Community 1020 receives 240 bids by Transportation Providers 1030 for providing desired rides, and/or a UD 1010 for User 1012 receives 244 bids by Transportation Providers 1030 for providing desired rides. It will be obvious to one of skill in the art that the receipt of bids by a plurality of UD 1010 may or may not be simultaneous or may happen over a large interval of time, but will happen after a given UD 1010 has sent information on desired rides. It has been found advantageous, in some embodiments of the present invention, to have the UD 1010 receive 247 a CMTP from the system 1000 at approximately the same time that a UD 1010 receives 244 bids by Transportation Providers 1030, although the UD 1010 may receive 247 the CMTP from the system 1000 at a different time from approximately when the UD 1010 receives 244 bids by Transportation Providers 1030.

Thereafter, each UD 1010 that has received bids presents 246 bids to a User 1012 for the Community 1020 or presents 248 bids to a User 1012. Later, the UD 1010 for Community 1020 sends 250 an acceptance or rejection to the system 1000, and/or the UD 1010 for User 1012 sends 254 an acceptance or rejection to the system 1000. Thereafter, the UD 1010 receives 260 a payment request, and after that, the UD 1010 sends 270 payment information to the inventive system 1000.

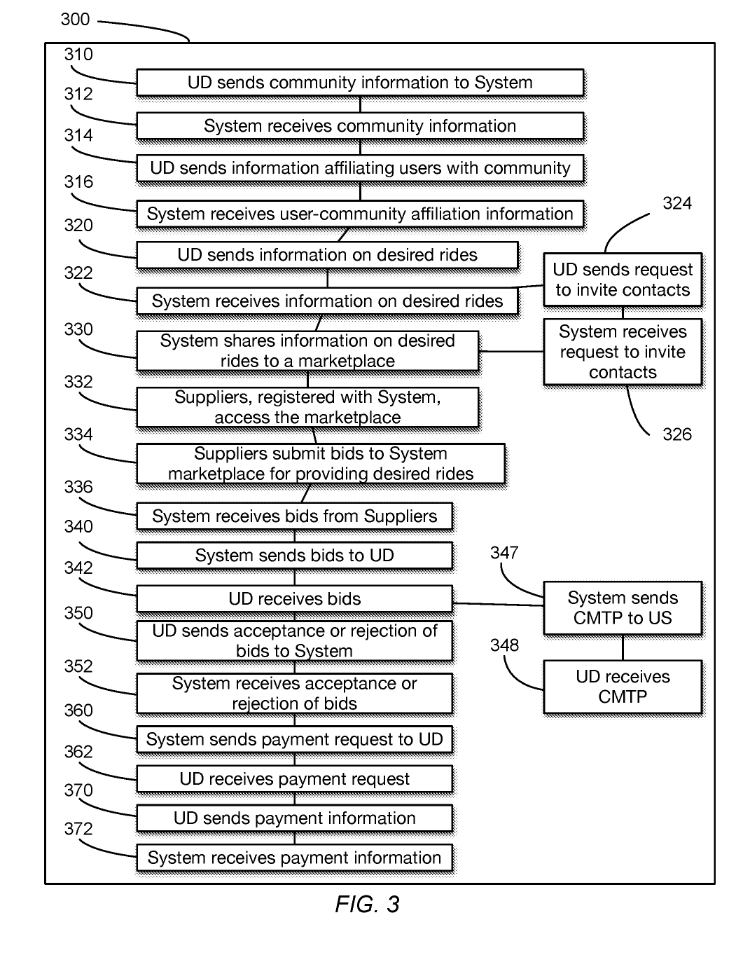

With reference to FIG. 3, a method 300 is presented, from the perspective of a third party external to the system 1000 and the UD 1010, of the inventive system 1000 providing a method of community-based transportation management. In this inventive method 300, a UD 1010 sends 310 community information to the system 1000, and the system 1000 receives 312 the community information. Thereafter, the UD 1010 sends 314 information affiliating a plurality of Users 1012 with a Community 1020, and the system 1000 receives 316 the User-Community affiliation information. At a later time, the UD 1010 sends 320 information on desired rides to the system 1000, and the system 1000 receives 322 the information on desired rides; all such information is also referred to individually and collectively as the ride criteria. The information sent 320 and received 322 may include or be followed by the UD 1010 sending 324 a request to invite contacts of the User 1012 to the desired ride; after which the system 1000 receives 326 the request to send invitations to one or more of the specified contacts of the User 1012; such invitations comprise a request for the contact of the User 1012 to join the ride, and may comprise further items or requests. Thereafter, the system 1000 shares 330 the information on desired rides to a marketplace 1060.

Thereafter, Transportation Providers 1030 access 332 the marketplace 1060, and later, Transportation Providers 1030 submit 334 bids to the system 1000 marketplace 1060 for providing desired rides. The system 1000 receives 336 the bids from Transportation Providers 1030, and later, the system 1000 sends 340 bids to the UD 1010. UD 1010 receives 342 the bids, and later, UD 1010 sends 350 acceptance or rejection of bids to system 1000. The system 1000 receives 352 acceptance or rejection of bids, and at a later time, the system 1000 sends 360 a payment request to UD 1010. The UD 1010 receives 362 the payment request, and later, the UD 1010 sends 370 payment information to the system 1000. The system 1000 receives 372 payment information from the UD 1010. It has been found advantageous, in some embodiments of the present invention, to have the system 1000 send 347 a CMTP to a UD 1010 at approximately the same time that a UD 1010 receives 342 bids by Transportation Providers 1030, although the system 1000 may send 347 the CMTP at a different time from approximately when the UD 1010 receives 342 bids by Transportation Providers 1030. After the system 1000 sends 347 the CMTP, the UD 1010 receives 348 the CMTP from the system 1000.

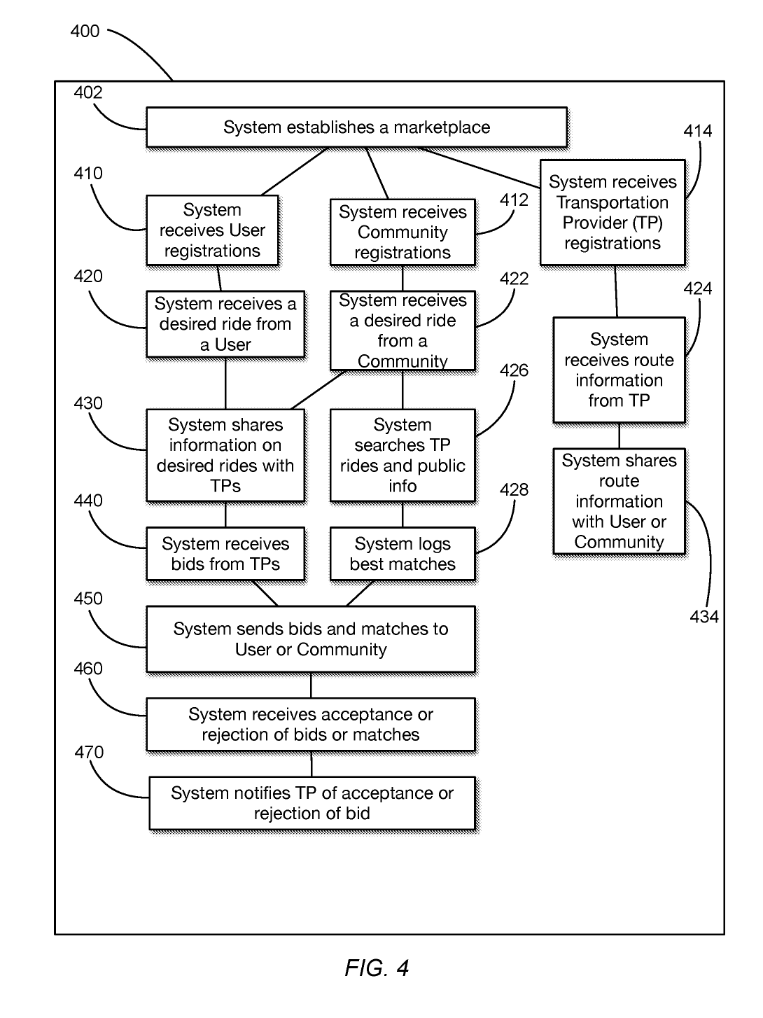

With reference to FIG. 4, a method 400 is presented, from the perspective of the system 1000, of the inventive system 1000 providing a transportation marketplace. The system 1000 establishes 402 a marketplace 1060. It will be obvious to one of skill in the art that the system 1000 may establish a plurality of marketplaces, which may be a first marketplace 1060, a second marketplace 1062, a third marketplace 1064, or any number of marketplaces. The plurality of marketplaces may be controlled and processed by a marketplace module 1068, in the system 1000. Thereafter, the system 1000 receives 410 a plurality of User 1012 registrations. The system 1000 also receives 412 a plurality of Community 1020 registrations. The system 1000 also receives 414 a plurality of Transportation Providers 1030 registrations. Each such registration includes the system associating each of the Users 1012, Communities 1020, and Transportation Providers 1030 with the marketplace 1060 or with one or more of the plurality of marketplaces, and also includes but is not limited to identifying information, contact information, and transportation preferences and needs information, e.g. whether a User 1012 needs wheelchair accessibility, or dislikes buses.

After registering a User 1012, the system 1000 receives 420 a desired ride from the User 1012. After registering a Community 1020, the system 1000 receives 422 a desired ride from the Community 1020. A desired ride is any transportation desired by a User 1012 Community 1020, whether the transportation comprises or requires one or more modes of transportation (e.g., car, bus, van, boat, bicycle, airplane, animal-powered transportation, or other), that involves travel from one place to another, whether or not the travel is intended as a round-trip, one-way, open-jaw, or other type of trip or booking. A desired ride may be a single trip, multiple trips, and may be a recurring trip. After receiving 420 a desired ride from a User 1012 or receiving 422 a desired ride from a Community 1020, the system 1000 may search 426 some or all of the rides said to be provided by one or more Transportation Providers 1030, and/or publicly available information. Such searches can include multiple forms of transportation: public, private, ride-sharing, and/or dynamic transportation systems. After so searching 426, the system 1000 logs 428 the best matches for the desired ride. After registering a Transportation Provider 1030, the system 1000 receives 424 route information from a Transportation Provider 1030, which in some embodiments of the present invention may take the form of an enterprise-level portal for a Transportation Provider 1030 to upload routes the Transportation Provider 1030 is using and offering, view and access their billings and collections information, and more. Route information may include but is not limited to the Transportation Provider's 1030 routes on which they offer transportation, modes of transportation and vehicle types and capacities, schedules, wheelchair accessibility, pricing, and service hours. Route information may also include information regarding what services and accommodations a Transportation Provider 1030 does or does not offer: for instance, offering services or a particular route only to a the members of a Community 1020; or whether the Transportation Provider 1030 can allow its drivers (the people who work for the Transportation Provider 1030 and drive the relevant vehicle or other means of transportation) to accept a trip, so that the Transportation Provider 1030 doesn't have to assign the trip to a driver. Because public agencies and third-party suppliers of transportation can send or share digital information about schedules and route maps to the inventive system 1000, all routes and schedules are searchable by consumers and communities 1020, and by the system 1000, with mapping and/or routing information searchable in real time—and the system 1000 may, it has been found advantageous, calculate and suggest one or more routes to a plurality of Users 1012 and/or a plurality of Communities 1020. Thereafter, the system 1000 shares 430 information on desired rides with a Transportation Provider 1030, and the system 1000 shares 434 route information with a User 1012 and/or a Community 1020. At a later time, the system 1000 receives 440 bids from a plurality of Transportation Providers 1030. The bids relate to the price or prices at which the Transportation Provider 1030 is willing to offer service to meet the rides requested by a plurality of Users 1012 and/or a plurality of Communities 1020. A Transportation Provider 1030 can bid only after it has a ride that it can provide that matches the desired criteria of the user 1012 or community 1020 requesting the transportation services. In some embodiments of the present invention, a Transportation Provider 1030 must bid on all of a desired ride, or not bid at all; in other embodiments of the invention, the Transportation Provider 1030 is allowed to bid on all of a desired ride or may bid on a plurality of discrete legs of the desired ride. In either such embodiment of the present invention, the Transportation Provider 1030 can of course choose what it wants to bid on, within the constraints of the embodiment of the present invention. When a desired ride is for a recurring trip, it has been found advantageous to allow a Transportation Provider 1030 to bid on the desired ride for all or only some of the days on which the trip recurs.

Later, the system 1000 sends 450 bids and/or matches to a User 1012 or a Community 1020. Thereafter, the system 1000 receives 460 acceptance or rejection of bids and/or matches. After that, the system 1000 notifies 470 the Transportation Provider 1030 which had provided a bid of acceptance or rejection of that bid. Any particular Transportation Provider 1030 can assign a trip for which it has won the bid to a driver, and/or allow drivers to accept trips. Drivers for a particular Transportation Provider 1030 can see information about the routes and stops they are assigned or have selected. Drivers can also scan CMTPs. In a marketplace 1060, any particular Transportation Provider 1030 can access their billing information, to view what they have billed and received, what transactions they've been a party to, and what they have billed and not collected on.

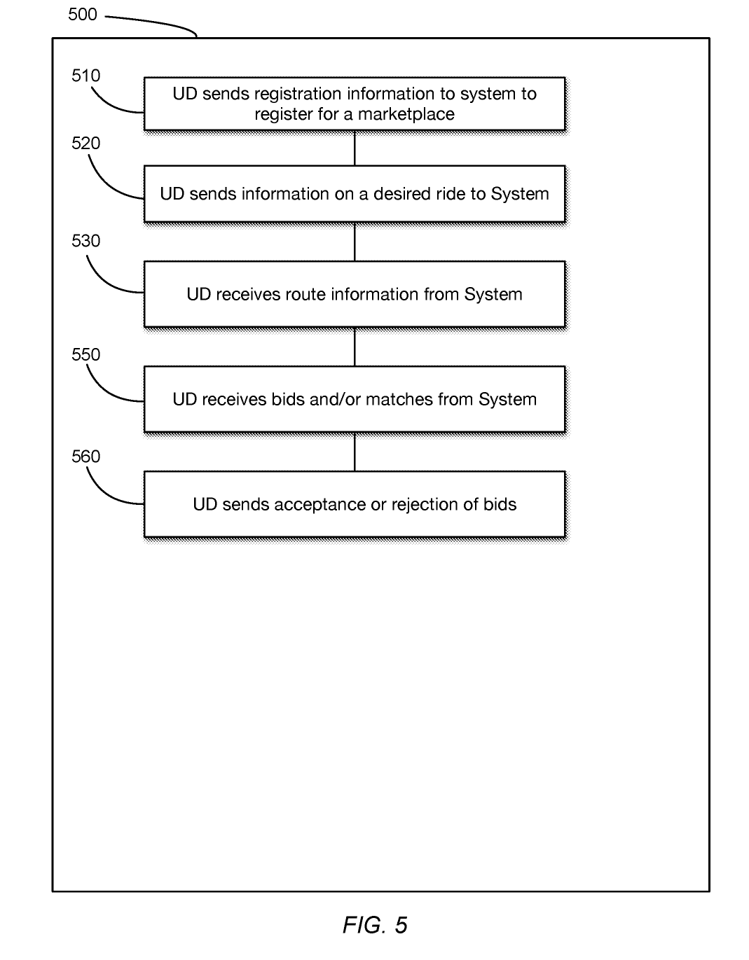

With reference to FIG. 5, a method 500 is presented, from the perspective of a UD 1010, of the inventive system 1000 providing a transportation marketplace. A UD 1010 sends 510 registration info to system 1000 to register for a marketplace 1060, or for a plurality of marketplaces. Thereafter, the UD 1010 sends 520 information on a desired ride to system 1000. Later, the UD 1010 receives 530 route information from the system 1000. At a later time, the UD 1010 receives 550 bids and/or matches from the system 1000 for the desired ride sent 520 previously to the system 1000. Thereafter, the UD 1010 sends 560 acceptance or rejection of bids and/or matches.

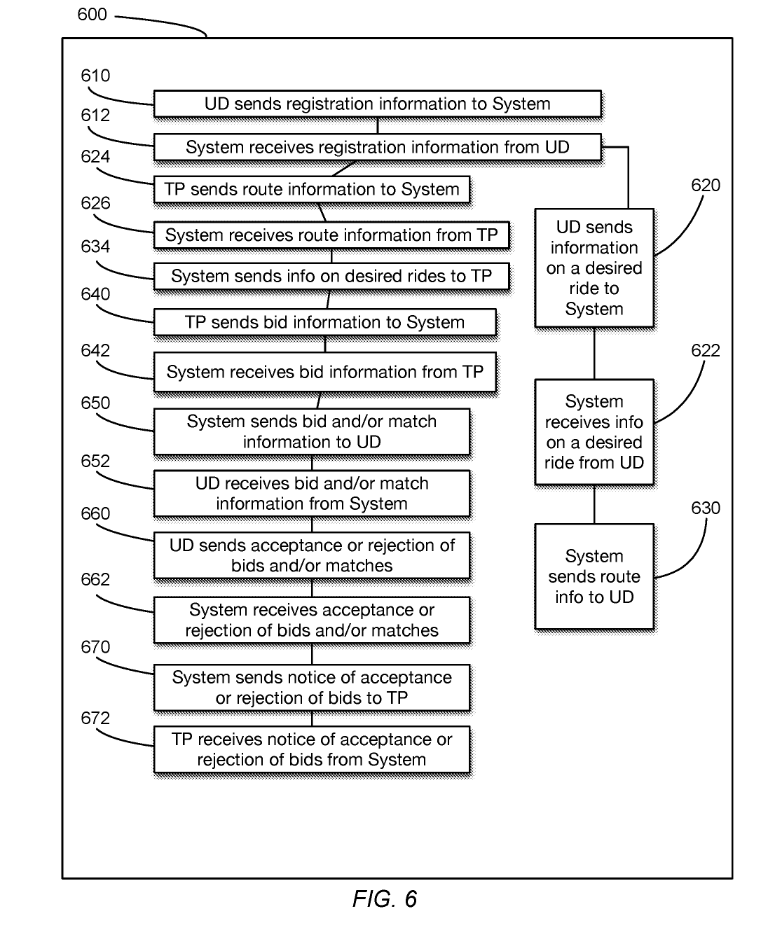

With reference to FIG. 6, a method 600 is presented, from the perspective of a third party external to the system 1000 and to the UD 1010, of the inventive system 1000 providing a transportation marketplace. The UD 1010 sends 610 registration info to system 1000, to register as discussed previous a plurality of Users 1012 and/or a plurality of Communities 1020. The system 1000 receives 612 registration info from UD 1010. At a later time, the UD 1010 sends 620 information on a desired ride to system 1000, where a desired ride has the meaning discussed above. The system 1000 receives 622 the information on a desired ride from UD 1010.

A Transportation Provider 1030 sends 624 route information to system 1000, and the system 1000 receives 626 the route information from Transportation Provider 1030, where the route information has the meaning discussed above. At a later time, the system 1000 sends 630 route information to UD 1010. The system 1000 sends 634 information on desired rides to the Transportation Provider 1030. Later, the Transportation Provider 1030 sends 640 bid information to system 1000, and the system 1000 receives 642 the bid information from Transportation Provider 1030, where bid information has the meaning described above.

Thereafter, the system 1000 sends 650 bid information and/or matches information to UD 1010. The UD 1010 receives 652 bid information and/or matches information from system 1000. At a later time, the UD 1010 sends 660 acceptance or rejection of bids and/or matches to system 1000, and the system 1000 receives 662 acceptance or rejection of bids and/or matches from UD 1010. Later, the system 1000 sends 670 notice of acceptance or rejection of bids to Transportation Provider 1030, and the Transportation Provider 1030 receives 672 notice of acceptance or rejection of bids from system 1000.

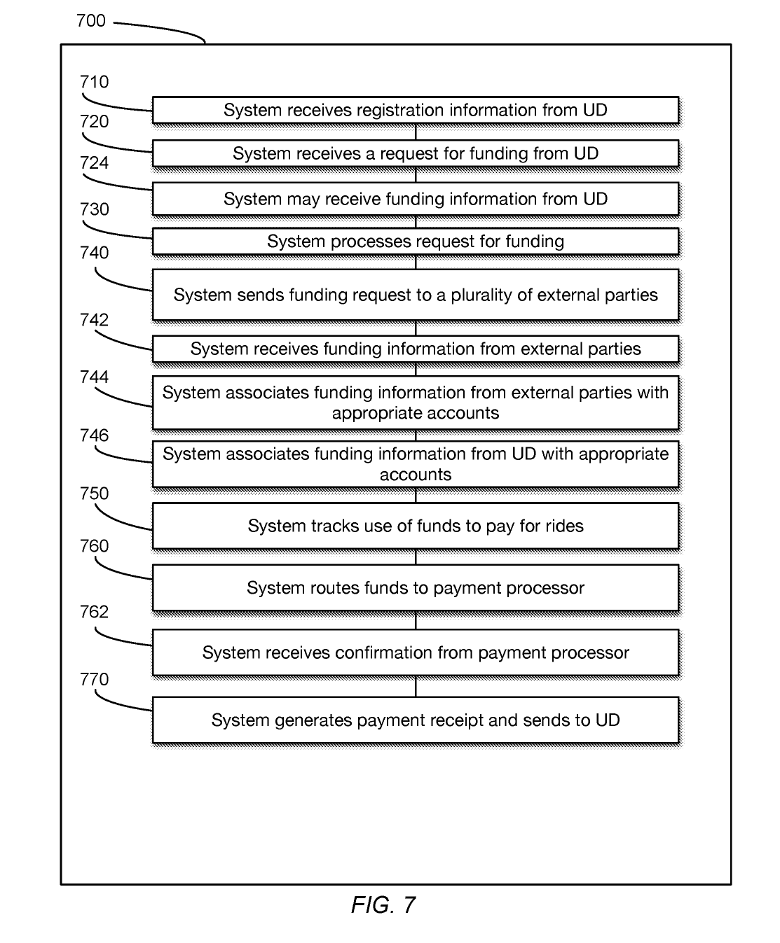

With reference to FIG. 7, a method 700 is presented, from the perspective of the system 1000, of the inventive system 1000 providing a method of user-based and community-based transportation funding and payment. In the inventive method, the system 1000 receives 710 registration information from UD 1010, where registration information has the meaning discussed above. Thereafter, the system 1000 receives 720 a request for funding from UD 1010. The system 1000 may receive 724 funding information from UD 1010. As used throughout the disclosure of the present invention, funding or funding information refers to a method of payment and a payer who will pay for part or all of one or more legs of a desired ride that is to be booked by or for a User 1012. A method of payment may be a credit card or other revolving line of credit, or a prepaid account, or a debit card to debit a bank account, or may be other means now known or later invented, and the payer may be the User 1012, a Community 1020, an individual other than the User 1012, a government agency, a company, a crowdfunding campaign, or other entities or sources. Note that the while the method of payment may be crowdfunding, the presently described transportation funding is distinct from other types of crowdfunding because the inventive system accepts and holds the raised funds, and parcels the funds out to users or communities for use only on approved transportation services. The funds are for transport only, and their use can be audited. In contrast, prior art crowdfunding merely gives the funds to a user, at which point they can be used by the user for anything.

Later, the system 1000 processes 730 the request for funding, and after that, the system 1000 sends 740 the funding request to a plurality of external parties 1040 which may raise or contribute funding to pay the one or more Transportation Providers 1030 for the desired ride or rides. The system 1000 can also allow an administrative User 1012 in a Community 1020 to designate any User 1014 or other entity to pay transportation costs for any other User 1016 who is a member of that Community 1020, whether those transportation costs are paid using Community 1020 funds (by a User 1014 who is a member of that Community 1020) or other funds. Thereafter, the system 1000 receives 742 funding information from a plurality of external parties 1040, and the system 1000 then associates 744 funding information from a plurality of external parties 1040 with appropriate accounts, which accounts may be associated with a plurality of Users 1012 and/or a plurality of Communities 1020. The system 1000 associates 746 funding information from the UD 1010 with appropriate accounts, which may be only for the User 1012 associated with that UD 1010, or may be for one or more other Users 1014 and/or one or more Communities 1020.

At a later time, the system 1000 tracks 750 use of funds to pay for rides. The system 1000 routes 760 funds to a payment processor 1050, and the system 1000 later receives 762 confirmation from a payment processor 1050 that payment was sent to the appropriate one or more Transportation Providers 1030. Later, the system 1000 generates 770 a payment receipt and sends the payment receipt to UD 1010. The payment receipt may be a printable image, or a scannable code to be displayed on the screen of the UD 1010 or other mobile device, or other means now known or later invented. The payment receipt may be used as proof of payment by the User 1012 to gain access to the one or more transportation modes used by the plurality of Transportation Providers 1030 to provide the service for the desired ride.

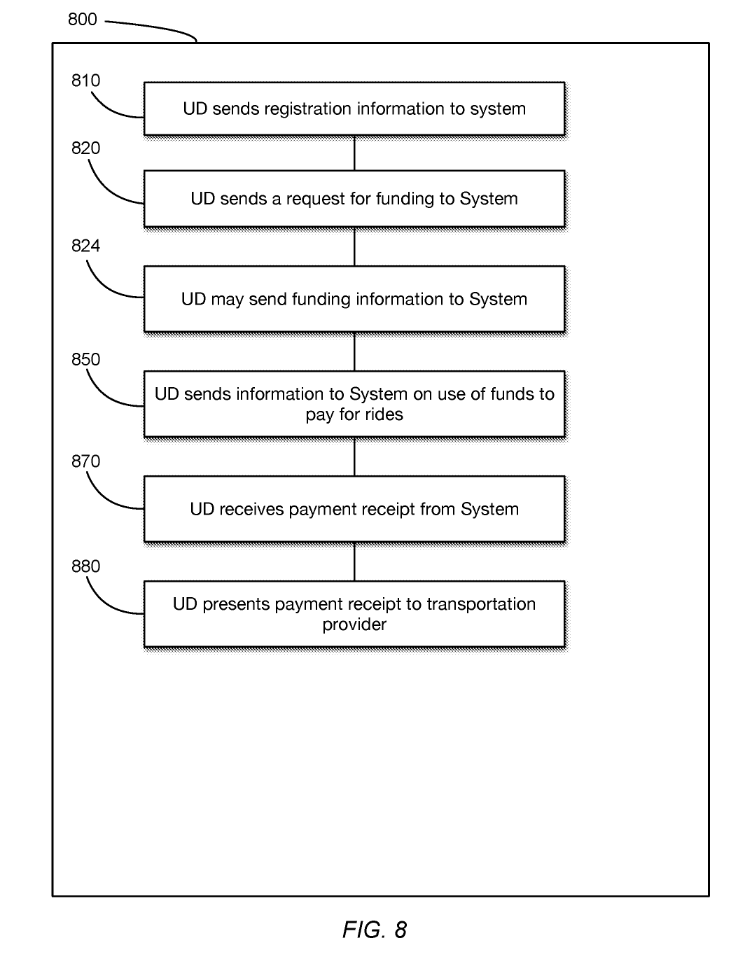

With reference to FIG. 8, a method 800 is presented, from the perspective of a UD 1010, of the inventive system 1000 providing a method of user-based and community-based transportation funding and payment. In the inventive method, the UD 1010 sends 810 registration info to system 1000. Later, the UD 1010 sends 820 a request for funding to system 1000, and the UD 1010 may send 824 funding information to system 1000. At a later time, the UD 1010 sends 850 information to system 1000 on use of funds to pay for rides. Thereafter, the UD 1010 receives 870 a payment receipt from system 1000. Later, the UD 1010 presents 880 the payment receipt to Transportation Provider 1030 to demonstrate payment and be allowed access to the mode or modes of transportation.

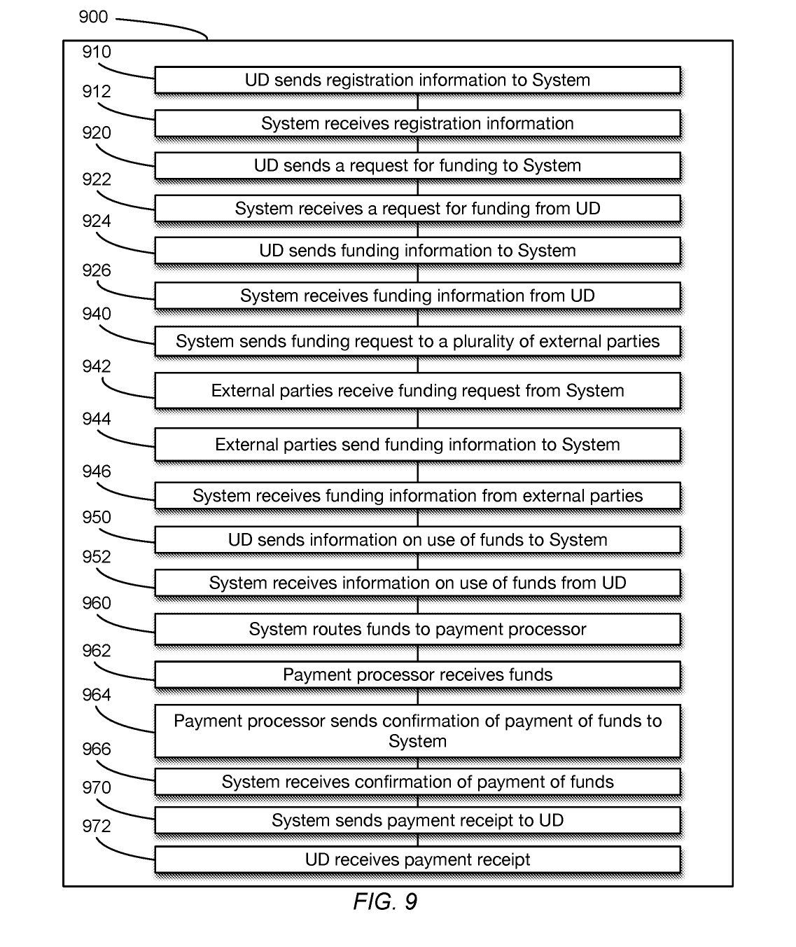

With reference to FIG. 9, a method 900 is presented, from the perspective of a third party external to the system 1000 and a UD 1010, of the inventive system 1000 providing a method of user-based and community-based transportation funding and payment. In the inventive method, a UD 1010 sends 910 registration info to system 1000, and the system 1000 receives 912 the registration info. Later, the UD 1010 sends 920 a request for funding to system 1000, and the system 1000 receives 922 a request for funding from UD 1010.

Thereafter, the UD 1010 sends 924 funding information to system 1000, and the system 1000 receives 926 the funding information from UD 1010. Later, the system 1000 sends one or more funding requests to a plurality of external parties 1040, and the plurality of external parties 1040 receive 942 the funding request from system 1000. At a later time, the plurality of external parties 1040 send 944 funding information to system 1000, and the system 1000 receives 946 funding information from the plurality of external parties 1040.

At a later time, the UD 1010 sends 950 information on use of funds to system 1000, and the system 1000 receives 952 information on use of funds from UD 1010. Later, the system 1000 routes 960 funds to payment processor 1050, and the payment processor 1050 receives 962 funds. Thereafter, the payment processor 1050 sends 964 confirmation of payment of funds to system 1000. Alternatively, the system 1000 may utilize the payment module 1080 to handle the payment to the payee or payees, or may use the payment module 1080 to process communications with the payment processor 1050.

Later, the system 1000 receives 966 confirmation of payment of funds. Thereafter, the system 1000 sends 970 a payment receipt to UD 1010, and the UD 1010 receives 972 the payment receipt.

With reference to FIG. 10, the inventive system 1000 is shown in a schematic depiction of the environment in which it operates, including but not limited to relevant third parties with which the system 1000 interacts in carrying out various of the inventive methods described here. The system communicates with a plurality of user devices 1010, which may each be any device or apparatus capable of communication with an inventive system 1000, and which may communicate with the inventive system 1000 via proprietary communications through a purpose-built application, or via text messages, emails, voice commands, image recognition, or other means of communicating information or commands now known or later invented. A UD 1010 may be used by a first User 1012, a second User 1014, or any of a number of other users. It will be obvious to one of skill in the art that a plurality of users can interact with the inventive system 1000, using a UD 1010. Similarly, a UD 1010 may be used by an authorized representative of a first Community 1020, or an authorized representative of a second Community 1022, or as will be obvious to one of skill in the art, by one or more authorized representatives of any of a plurality of communities. For the sake of simplicity and readability in the present disclosure, references herein to a singular User 1012 are to be understood to mean any of the plurality of users who may interact with the system 1000, and likewise, references herein to a singular Community 1020 are to be understood to mean any of the plurality of communities who may interact with the system 1000. The system 1000 also communicates with a plurality of Transportation Providers 1030. A Transportation Provider 1030 may be a government transportation agency, a semi-governmental agency, a public-private partnership, an entity offering ride-sharing or ride-facilitation, a nonprofit or for-profit entity operating transportation services, volunteer driver, a ride-hailing service provider or other type of entity.

The system 1000 may also communicate with external parties 1040 for purposes of funding rides for users or communities. External parties 1040 may include, but are not limited to, government agencies, educational institutions, healthcare institutions, towns, municipalities, non-profits, corporate sponsors, employers relevant to a user or a community, neighborhood organizations, religious or fraternal organizations, crowdfunding or fundraising entities, or other types of entities. The system 1000 also communicates with one or more payment processors 1050, to direct funds to one or more Transportation Providers 1030.

With reference to FIG. 10, FIG. 11, and FIG. 12, schematic representations of the inventive system 1000 are presented. The system may establish a plurality of marketplaces for posting of transportation rides desired, viewing of offered routing information, bidding to provide service to meet the posted rides desired, and acceptance or rejection of bids. The plurality of marketplaces will enable the inventive system 1000 to forecast rides desired, and will allow Transportation Provider 1030 to establish and change the routes and transportation they offer to meet the present and forecasted demand for transportation. It will be obvious to one of skill in the art that the plurality of marketplaces may comprise a first marketplace 1060, a second marketplace 1062, a third marketplace 1064, or any number of marketplaces. For the sake of readability, references herein to a singular marketplace 1060 are to be understood to mean any of the plurality of marketplaces which may be established by the system 1000.

The inventive system 1000 may establish a marketplace module 1068, for operating one or more of the plurality of marketplaces. The marketplace module 1068 may be operated inside the system 1000 to carry out the inventive methods described above related to providing a transportation marketplace. The system may further comprise a transportation planner module 1070, which carries out the functions disclosed in the methods described above related to transportation planning for a User 1012 and/or a Community 1020. The system may further comprise a scheduling and routing module 1074, which may be operated by the system 1000 to plan a route, utilizing one or more Transportation Provider 1030 and the routing information provided, for a User 1012 and/or a Community 1020 that matches the ride desired. The system may also comprise a payment module 1080, which may be used by the system 1000 in addition to or instead of a payment processor 1050, to process payments to a plurality of Transportation Providers 1030, as described in relevant methods above. The system may also comprise a forecasting module 1090, which may be used to process information on rides desired, and routing information, and information on use of funds, to allow the system 1000 to forecast future demand for transportation, providing a significant improvement over the current art. Any and all of the foregoing modules may be implemented with the plurality of processors 1100.

These and other possible modules may be in operative communication with each other within the system 1000, that is, the marketplace module 1068 may communicate with each of the transportation planner module 1070, the scheduling and routing module 1074, the payment module 1080, and the forecasting module 1090, and each other module may communicate with the others.

The system 1000 may comprise a plurality of processors 1100, a plurality of input devices 1110, a plurality of displays 1120, a first i/o device 1130, a second i/o device 1140 (and it will be obvious to one of skill in the art that a plurality of i/o devices are possible), a plurality of memories 1150, a plurality of computer-readable media 1160 which may be used to store a plurality of computer-readable instructions 1170, and a plurality of databases 1180. The databases 1180 may be used to store any of the plurality of types of information disclosed above, including but not limited to routing and scheduling information, mapping information, route capacity information, user accounts, community accounts, rides desired, bids, use of funds, and payment information. The computer-readable instructions 1170 may store instructions for carrying out one or more of the inventive methods. The memories 1150 may be used by the processors 1100 to carry out any of the functions or steps described herein. The input devices 1110 and displays 1120 may be used to control the system 1000. The processors 1100 may be in operative communication with any of the foregoing elements and modules of the system, and with any of the plurality of i/o devices, which may be used for communication with entities external to the system 1000, as described above.

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, interactive voice response systems, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device, also referred to as a processor 1100, may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, the iOS operating system, the Android operating system, the Chrome operating system, an OPENSTEP operating system or another operating system or platform.

Any suitable programming language may be used to implement without undue experimentation the data-gathering and analytical functions described above. Illustratively, the programming language used may include assembly language, Ada, APL, Basic, C, C++, C#, VB.NET, COBOL, dBase, Forth, FORTRAN, Java, Modula-2, Pascal, PHP, Prolog, Python, Qt, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Communication protocols on wireless communication or cellular networks may include CDMA, GSM, or other protocols now known or later invented. Furthermore, components of the system may communicate through a combination of wired or wireless paths.

Certain embodiments of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A method, stored in computer-readable media, for community-based transportation management, from the perspective of the inventive system, the method comprising:
a system receives information establishing a Community; then
the system receives information affiliating a plurality of Users with a Community; then
the system receives information on desired rides from a Community; then
the system shares information on desired rides to a marketplace; then
the system receives bids from Transportation Providers; then
the system sends bids; then
the system receives acceptance or rejection of a bid.

2. The method of claim 1, in which the method further comprises the system receives information on desired rides from a User.

3. The method of claim 2, in which the method further comprises the system receives a request to invite contacts of the User to the desired ride, after which the system sends invitations to one or more of the specified contacts of the User.

4. The method of claim 1, in which the method further comprises the system sends a bid to a Community, and later receives acceptance or rejection the bid from the Community.

5. The method of claim 1, in which the method further comprises the system sends a bid to a User, and later receives acceptance or rejection the bid from the User.

6. The method of claim 1, in which the method further comprises the system sends a payment request to the Community or the User; then the system receives payment information.

7. The method of claim 1, in which the method further comprises the system establishing a Community-Managed Transport Pass, after which the system sends the CMTP to a user.

8. A method, stored in computer-readable media, for community-based transportation management, from the perspective of a user device, the method comprising:
a UD sends information establishing a Community to the system; then
the UD sends information affiliating a plurality of Users with a Community; then
the UD sends information on desired rides for a Community; then
the UD for a Community receives bids by Transportation Providers for providing desired rides; then
the UD presents bids to a User for the Community; then
the UD for Community sends an acceptance or rejection to the system; then
the UD receives a payment request; then
the UD sends payment information to the system.

9. The method of claim 8, in which the method further comprises the same or a different UD sends information on desired rides for a User; then
the UD for a User receives bids by Transportation Providers for providing desired rides; then
the UD presents bids to the User; then
the UD sends an acceptance or rejection to the system.

10. The method of claim 9, in which the method further comprises the UD sending a request to invite contacts of a User to the desired ride.

11. The method of claim 9, in which the method further comprises the UD receiving a CMTP from the system.

12. A method, stored in computer-readable media, for community-based transportation management, from the perspective of a third party external to the system and the UD, the method comprising:
a UD sends community information to the system; then
the system receives the community information; then
the UD sends information affiliating a plurality of Users with a Community; then
the system receives the User-Community affiliation information; then
the UD sends information on desired rides to the system; then
the system receives the information on desired rides; then
the system shares the information on desired rides to a marketplace; then
Transportation Providers access the marketplace; then
Transportation Providers submit bids to the system marketplace for providing desired rides; then
the system receives the bids from Transportation Providers; then
the system sends bids to the UD; then
the UD receives the bids; then
the UD sends acceptance or rejection of bids to system; then
the system receives acceptance or rejection of bids; then
the system sends a payment request to UD; then
the UD receives the payment request; then
the UD sends payment information to the system; then
the system receives payment information from the UD.

13. The method of claim 12, in which the method further comprises, after the system receives the information on desired rides, the UD sends a request to invite contacts of the User to the desired ride; after which the system receives the request to send invitations to one or more of the specified contacts of the User.

14. The method of claim 12, in which the method further comprises, after the UD receives the bids, the system sends a CMTP to a UD, after which the UD receives the CMTP from the system.

15. A method, stored in computer-readable media, for providing a transportation marketplace, from the perspective of the inventive system, the method comprising:
the system establishes a marketplace; then
the system receives a plurality of User registrations; then after registering a User, the system receives a desired ride from the User; and
the system receives a plurality of Community registrations; then after registering a Community, the system receives a desired ride from the Community; then
the system shares information on desired rides with a Transportation Provider.

16. The method of claim 15, in which the method further comprises:
the system receives a plurality of Transportation Providers registrations; then
the system receives route information from a Transportation Provider; then
the system shares route information with a User and/or a Community.

17. The method of claim 15, in which the method further comprises, after receiving a desired ride from a User or receiving a desired ride from a Community, the system searches some or all of the rides said to be provided by one or more Transportation Providers, and/or publicly available information; then the system logs the best matches for the desired ride.

18. The method of claim 15, in which the method further comprises, after the system shares information on desired rides with a Transportation Provider:
the system receives bids from a plurality of Transportation Providers; then
the system sends bids and/or matches to a User or a Community; then
the system receives acceptance or rejection of bids and/or matches; then
the system notifies the Transportation Provider.

19. A method, stored in computer-readable media, for providing a transportation marketplace, from the perspective of a user device, the method comprising:
a UD sends registration info to system to register for a plurality of marketplaces; then
the UD sends information on a desired ride to system; then
the UD receives route information from the system; then
the UD receives bids and/or matches from the system for the desired ride; then
the UD sends acceptance or rejection of bids and/or matches.

20. A method, stored in computer-readable media, for providing a transportation marketplace, from the perspective of a third party external to the system and to the UD, the method comprising:
a UD sends registration info to system; then
the system receives registration info from UD; then
the UD sends information on a desired ride to system; then
the system receives the information on a desired ride from UD; and
a Transportation Provider sends route information to system; then
the system receives the route information from Transportation Provider; then
the system sends route information to UD; then
the system sends information on desired rides to the Transportation Provider.

21. The method of claim 20, in which the method further comprises, after the system sends information on desired rides with a Transportation Provider:
the Transportation Provider sends bid information to system; then
the system receives the bid information from Transportation Provider; then
the system sends bid information and/or matches information to UD; then
the UD receives bid information and/or matches information from system; then
the UD sends acceptance or rejection of bids and/or matches to system; then
the system receives acceptance or rejection of bids and/or matches from UD; then
the system sends notice of acceptance or rejection of bids to Transportation Provider; then
the Transportation Provider receives notice of acceptance or rejection of bids from system.

22. A method, stored in computer-readable media, for user-based and community-based transportation funding and payment, from the perspective of the inventive system, the method comprising:
the system receives registration information from UD; then
the system receives a request for funding from UD; then
the system processes the request for funding; then
the system sends the funding request to a plurality of external parties; then
the system receives funding information from a plurality of external parties; then
the system associates funding information from a plurality of external parties with appropriate accounts.

23. The method of claim 22, in which the method further comprises the system receiving funding information from UD.

24. The method of claim 23, in which the method further comprises the system associating funding information from the UD with appropriate accounts.

25. The method of claim 22, in which the method further comprises, after the system associates funding information from a plurality of external parties with appropriate accounts, the system tracks use of funds to pay for rides.

26. The method of claim 22, in which the method further comprises, after the system associates funding information from a plurality of external parties with appropriate accounts,
the system routes funds to a payment processor; then
the system receives confirmation from a payment processor that payment was sent to the appropriate one or more Transportation Providers; then
the system generates a payment receipt and sends the payment receipt to UD.

27. A method, stored in computer-readable media, for user-based and community-based transportation funding and payment, from the perspective of a user device, the method comprising:
the UD sends registration info to system; then
the UD sends a request for funding to system; then
the UD sends information to system on use of funds to pay for rides; then
the UD receives a payment receipt from system; then
the UD presents the payment receipt to Transportation Provider.

28. The method of claim 27, in which the method further comprises, after the UD sends a request for funding to system, the UD sends funding information to system.

29. A method, stored in computer-readable media, for user-based and community-based transportation funding and payment, from the perspective of a third party external to the system and a UD, the method comprising:
a UD sends registration info to system; then
the system receives the registration info; then
the system sends one or more funding requests to a plurality of external parties; then
the plurality of external parties receive the funding request from system; then
the plurality of external parties send funding information to system; then
the system receives funding information from the plurality of external parties.

30. The method of claim 29, in which the method further comprises, after the system receives the registration information,
the UD sends a request for funding to system; then
the system receives a request for funding from UD; then
the UD sends funding information to system; then
the system receives the funding information from UD.

31. The method of claim 29, in which the method further comprises, after the system receives funding information from the plurality of external parties,
the UD sends information on use of funds to system; then
the system receives information on use of funds from UD.

32. The method of claim 29, in which the method further comprises, after the system receives funding information from the plurality of external parties,
the system routes funds to payment processor; then
the payment processor receives funds; then
the payment processor sends confirmation of payment of funds to system; then
the system receives confirmation of payment of funds; then
the system sends a payment receipt to UD; then
the UD receives the payment receipt.

33. A system of communicably connected components for community-based transportation management, for providing a transportation marketplace, and for user-based and community-based transportation funding and payment, the system comprising:
a plurality of processors implementing a transportation planner module, a payment module, a forecasting module, a scheduling and routing module, and a marketplace module;
a plurality of memories;
a plurality of computer-readable media, which store a plurality of computer-readable instructions;
a plurality of databases for storage of information related to community-based transportation management, information related to providing a transportation marketplace, and information related to user-based and community-based transportation funding and payment;
a plurality of input devices;
a plurality of displays; and
a plurality of input/out modules for communication with external parties and/or user devices.

34. Computer-readable instructions, stored in computer-readable media, for community-based transportation management, for providing a transportation marketplace, and for user-based and community-based transportation funding and payment.
